(19) United States
(12) Patent Application Publication
(10) Pub. No.: US 2015/0058574 A1
(43) Pub. Date: Feb. 26, 2015

(54) Increasing The Efficiency of Memory Resources In a Processor

(71) Applicant: Imagination Technologies Limited, Hertfordshire (GB)

(72) Inventors: Jason Meredith, Hemel Hempstead (GB); Robert Graham Isherwood, Buckingham (GB); Hugh Jackson, Parramatta (AU)

(21) Appl. No.: 14/456,873

(22) Filed: Aug. 11, 2014

(30) Foreign Application Priority Data
Aug. 20, 2013 (GB) 1314891.1

(51) Int. Cl. G06F 9/46; G06F 12/08

(52) U.S. Cl. CPC G06F 9/461; G06F 12/0875; G06F 2212/452
USPC 711/125

(57) ABSTRACT

Methods of increasing the efficiency of memory resources within a processor are described. In an embodiment, instead of including dedicated DSP indirect register resource for storing data associated with DSP instructions, this data is stored in an allocated and locked region within the cache. The state of any cache lines which are used to store DSP data is then set to prevent the data from being written to memory. The size of the allocated region within the cache may vary according to the amount of DSP data that needs to be stored and when no DSP instructions are being run, no cache resources are allocated for storage of DSP data.

### BACKGROUND

A processor typically comprises a number of registers and where the processor is a multi-threaded processor, the registers may be shared between threads (global registers) or dedicated to a particular thread (local registers). Where the processor executes DSP (Digital Signal Processing) instructions, the processor includes additional registers which are dedicated for use by DSP instructions.

A processor's registers 100 form part of a memory hierarchy 10 which is provided in order to reduce the latency associated with accessing main memory 108, as shown in FIG. 1. The memory hierarchy comprises or more caches and there are typically two levels of on-chip cache, L1 102 and L2 104 which are usually implemented with SRAM (static random access memory) and one level of off-chip cache, L3 106. The L1 cache 102 is closer to the processor than the L2 cache 104. The caches are smaller than the main memory 108, which may be implemented in DRAM, but the latency involved with accessing a cache is much shorter than for main memory. As the latency is related, at least approximately, to the size of the cache, the L1 cache 102 is smaller than the L2 cache 104 in order that it has lower latency. Additionally, a secondary memory 110 may be provided for storage of less frequently used instructions and/or data.

The embodiments described below are not limited to implementations which solve any or all of the disadvantages of known processors.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Methods of increasing the efficiency of memory resources within a processor are described. In an embodiment, instead of including dedicated DSP indirect register resource for storing data associated with DSP instructions, this data is stored in an allocated and locked region within the cache. The state of any cache lines which are used to store DSP data is then set to prevent the data from being written to memory. The size of the allocated region within the cache may vary according to the amount of DSP data that needs to be stored and when no DSP instructions are being run, no cache resources are allocated for storage of DSP data.

A first aspect provides a method of managing memory resources within a processor comprising: dynamically using a locked portion of a cache for storing data associated with DSP instructions; and setting a state associated with any cache lines in the portion of the cache allocated to and used by a DSP instruction, the state being configured to prevent the data stored in the cache line from being written to memory.

A second aspect provides a processor comprising: a cache; a load-store pipeline; and two or more channels connecting the load-store pipeline and the cache; and wherein a portion of the cache is dynamically allocated for storing data associated with DSP instructions when DSP instructions are executed by the processor and lines within the portion of the cache are locked.

Further aspects provide a method substantially as described with reference to any of FIGS. 3, 6 and 10 of the drawings; a processor substantially as described with reference to any of FIGS. 4, 5 and 7-9; a computer readable storage medium having encoded thereon computer readable program code for generating a processor as described herein; and a computer readable storage medium having encoded thereon computer readable program code for generating a processor configured to perform the method described herein.

The methods described herein may be performed by a computer configured with software in machine readable form stored on a tangible storage medium e.g. in the form of a computer program comprising computer readable program code for configuring a computer to perform the constituent portions of described methods or in the form of a computer program comprising computer program code means adapted to perform all the steps of any of the methods described herein when the program is run on a computer and where the computer program may be embodied on a computer readable storage medium. Examples of tangible (or non-transitory) storage media include disks, thumb drives, memory cards etc and do not include propagated signals. The software can be suitable for execution on a parallel processor or a serial processor such that the method steps may be carried out in any suitable order, or simultaneously.

The hardware components described herein may be generated by a non-transitory computer readable storage medium having encoded thereon computer readable program code.

This acknowledges that firmware and software can be separately used and valuable. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

The preferred features may be combined as appropriate, as would be apparent to a skilled person, and may be combined with any of the aspects of the invention.

### BRIEF DESCRIPTION OF THE DRAWINGS

Embodiments of the invention will be described, by way of example, with reference to the following drawings, in which:

FIG. 1 is a schematic diagram of a memory hierarchy;

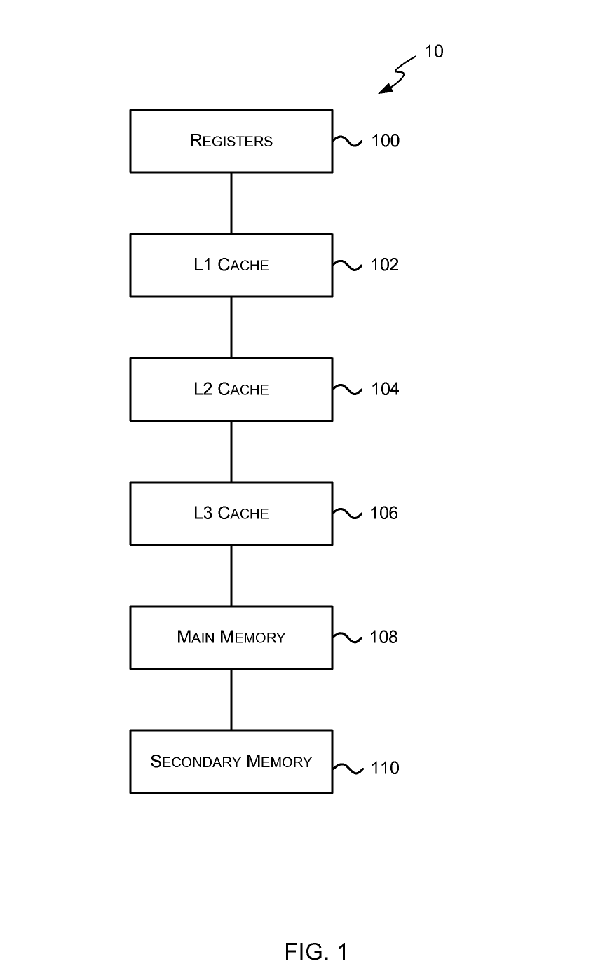

FIG. 2 is a schematic diagram of an example multi-threaded processor;

FIG. 3 is a flow diagram of an example method of operation of a processor in which the DSP register resource is absorbed within the cache, instead of having separate register resources dedicated for use by DSP instructions;

FIGS. 4A and 4B show schematic diagrams of two example caches;

FIG. 5 is a schematic diagram of DSP data access from another example cache;

FIG. 6 is a flow diagram which shows three example implementations of how a portion of a cache may be allocated to the DSP instructions and used to store DSP data;

FIG. 7 is a schematic diagram of an example multi-threaded processor in which the DSP register resource is absorbed within the cache;

FIG. 8 is a schematic diagram of an example single-threaded processor in which the DSP register resource is absorbed within the cache;

FIG. 9 is a schematic diagram of another example cache; and

FIG. 10 is a flow diagram of another example method of operation of a processor in which the DSP register resource is absorbed within the cache.

Common reference numerals are used throughout the figures to indicate similar features.

### DETAILED DESCRIPTION

Embodiments of the present invention are described below by way of example only. These examples represent the best ways of putting the invention into practice that are currently known to the Applicant although they are not the only ways in which this could be achieved. The description sets forth the functions of the example and the sequence of steps for constructing and operating the example. However, the same or equivalent functions and sequences may be accomplished by different examples.

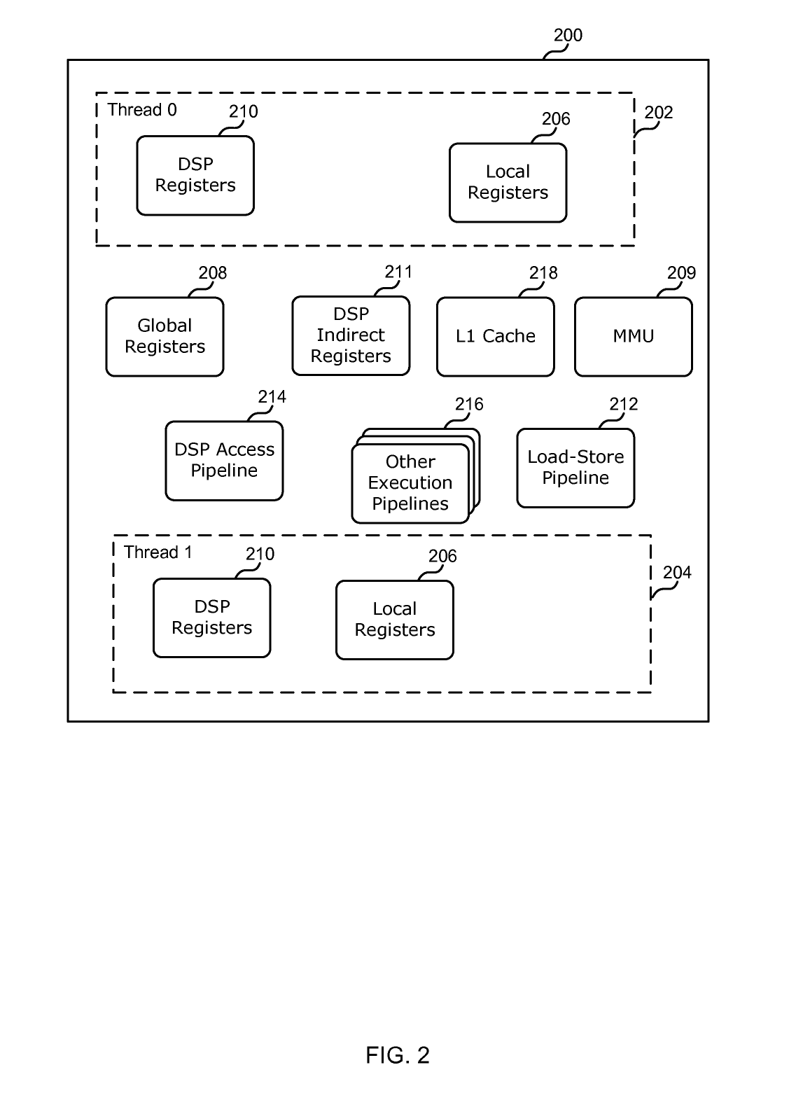

As described above, a processor which can execute DSP instructions typically includes an additional register resource which is dedicated for use by those DSP instructions. FIG. 2 shows a schematic diagram of an example multi-threaded processor 200 which comprises two threads 202, 204. In addition to local registers 206 and global registers 208, there are a small number of dedicated DSP registers 210 and a much larger number of indirectly accessed DSP registers 211 (which may be referred to as DSP indirect registers). These DSP indirect (or bulk) registers 211 are indirectly accessed registers as they are only ever filled from inside the processor (via the DSP Access Pipeline 214).

As shown in FIG. 2, some resources within the processor are replicated for each thread (e.g. the local registers 206 and DSP registers 210) and some resources are shared between threads (e.g. the global registers 208, DSP indirect registers 211, Memory Management Unit (MMU) 209, execution pipelines, including the load-store pipeline 212, DSP access pipeline 214 and other execution pipelines 216, and L1 cache 218). In such a processor, the DSP access pipeline 214 is used to store data in the DSP indirect registers 211 using indexes generated by values in related DSP registers 210. The DSP indirect registers 211 are an overhead in the hardware as the resource is large compared to the size of the DSP registers 210 (e.g. there may be about 24 DSP registers compared to around 1024 indirect DSP registers) and present whether or not DSP instructions that use it are being run. Furthermore, it is difficult to turn the DSP indirect registers 211 off as usage patterns may be sporadic and all of the current state would need to be preserved.

The following paragraphs describe a processor, which may be a single or multi-threaded processor and may comprise one or more cores, in which the DSP indirect register resource is not provided as a dedicated register resource but is instead absorbed into the cache state (e.g. the L1 cache). Also the functionality of the DSP access pipeline is absorbed into that of the Load-Store pipeline such that it is only the address range used to hold DSP indirect registers state within the L1 cache that identifies the special accesses to the cache. The L1 cache address range used is reserved for accesses to the DSP indirect register resource of each thread preventing any data contamination. Through use of dynamic allocation of the cache resources to DSP instructions, the register overhead is eliminated (i.e. there does not need to be any dedicated DSP indirect registers within the processor) along with the power overhead and the utilization of the overall memory hierarchy is more efficient (i.e. when no DSP instructions have been run, all cache resources are available for use in the standard way). As described in more detail below, in some examples, the size of the portion of the cache which is allocated to the DSP instructions can grow and shrink dynamically according to the amount of data that the DSP instructions need to store.

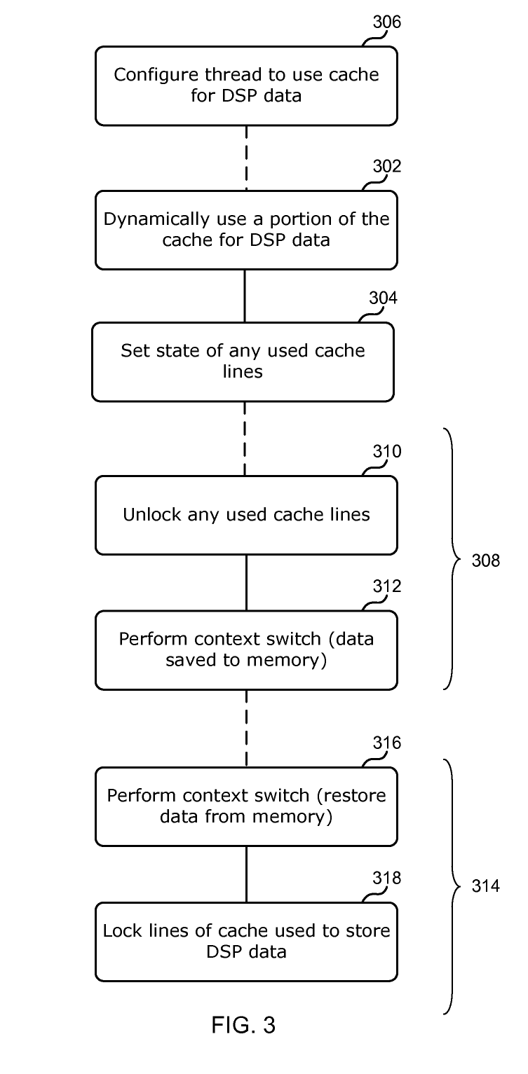

FIG. 3 shows a flow diagram of an example method of operation of a processor in which the DSP indirect register resource is absorbed within the cache, instead of having separate register resources dedicated for use by related DSP instructions. As shown in FIG. 3, a portion of a cache is dynamically used to store data associated with related DSP instructions (block 302) i.e. to store the data that would typically be stored in DSP indirect registers. The term “dynamically” is used herein to refer to the fact that the portion of the cache is only allocated for DSP use when it is required (e.g. at software runtime, at start-up, boot time or periodically) and furthermore, in some embodiments, the amount of cache allocated for use by DSP instructions may vary dynamically according to need, as described in more detail below. Cache lines which have been used to store DSP data are protected (or locked) such that they cannot be used as standard cache (i.e. the data stored in the lines cannot be evicted).

The parts of the cache (i.e. the cache lines) which are used to store data by related DSP instructions are not used in the same way that the cache is traditionally used because these values are only ever filled from inside the processor and they are not initially loaded from another level in the memory hierarchy or written back to any memory (except upon a context switch, as described in more detail below). Consequently, as shown in FIG. 3, the method further comprises setting the state of any cache lines which are used to store data by a related DSP instruction (block 304) to prevent the data from being written to memory. This state to which the cache lines are set may be referred to as Write never' in contrast to the standard write-back or write-though caches.

The state (‘write never’) and the locking of the cache lines used instead of DSP indirect register resource may be set using existing bits which indicate the state of a cache line. Allocation control information, which sets the bits (and hence performs the locking and sets the state), may be sent alongside each L1 cache transaction created by the Load-Store pipeline. This state is read and interpreted by the internal state machine of the cache such that when implementing an eviction algorithm, the algorithm determines that it cannot evict data from a locked cache line and instead has to select an alternative (non-locked) cache line to evict.

In an example, the setting of the state may be implemented by the Load-Store pipeline (e.g. by hardware logic within the Load-Store pipeline), for example the Load-Store pipeline may have access to a register which controls the state or the setting of the state may be controlled via address page tables as read by the MMU.

The method may comprise a configuration step (block 306) which sets up a register to indicate that a thread can use a portion of the cache for DSP data. This is a static set-up process in contrast to the actual allocation of lines within the cache (in block 302) which is performed dynamically. In some examples, all the threads in a multi-threaded processor may be enabled to use a portion of the cache for storing DSP data, or alternatively, only some of the threads may be enabled to use a portion of the cache in this way.

The registers which indicate that a thread can use a portion of the cache for DSP data may be located within the L1 cache or within the MMU. In an example, the L1 cache may include local state settings that indicate DSP-type lines within the cache and this information may be passed from the MMU to the L1 cache.

In order that the portion of the cache may be used instead of DSP indirect registers to store the DSP data, the cache architecture is modified so that the required amount of information can be accessed from the portion of the cache by the DSP instructions. In particular, to enable two reads or one read and one write to be performed at the same time (i.e. simultaneously) the number of semi-independent data accesses to the cache is increased, for example by providing two channels to the cache and the cache is partitioned (e.g. the cache architecture is split into two storage elements) to provide two sets of locations for the two channels. In an example implementation, the access ports to the cache may be expanded to present two load ports and one store port (where the store port can access either of the two storage elements).

The term ‘semi-independent’ is used in relation to the data accesses to the cache because each DSP operation may use a number of DSP data items, but there are set relations between those that are used together. The cache therefore can arrange storage of sets of items, knowing that only particular sets will be accessed together.

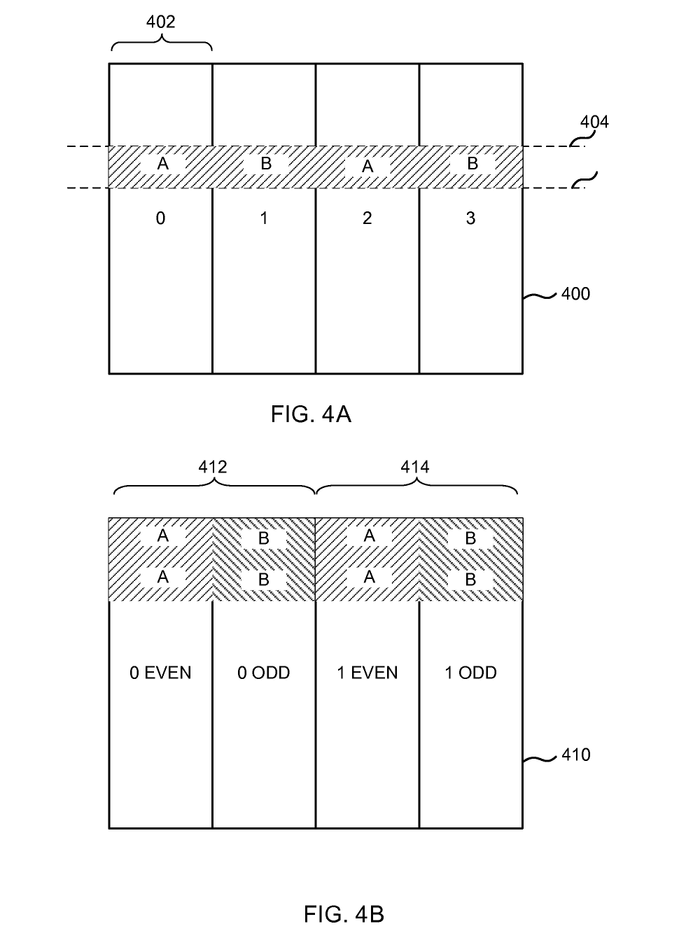

FIG. 4A shows a first schematic diagram of an example cache 400 which is divided into four ways 402 (labeled 0-3) and then split horizontally (by dotted lines 404) to provide two sets of locations for the two channels, with in this example, the parts of the even ways (0 and 2) comprising one set (labeled A) and the parts of the odd ways (1 and 3) comprising the other set (labeled B). In this implementation, the cache architecture is structured to store the two sets of DSP data (A and B) within independent storage elements, allowing the required concurrent accesses for DSP operations to be performed on the same clock cycle.

FIG. 4B shows a second schematic diagram of an example cache 410, which consists of two ways 412, 414 (labeled 0-1) that are each divided into two banks (EVEN and ODD) which provide two storage elements selected on the address of the access for each way 412, 414. For example, the division may store data set A within only evenly addressed cache lines and data set B within oddly addressed cache lines, allowing concurrent accesses to both set A and set B via the independent storage elements.

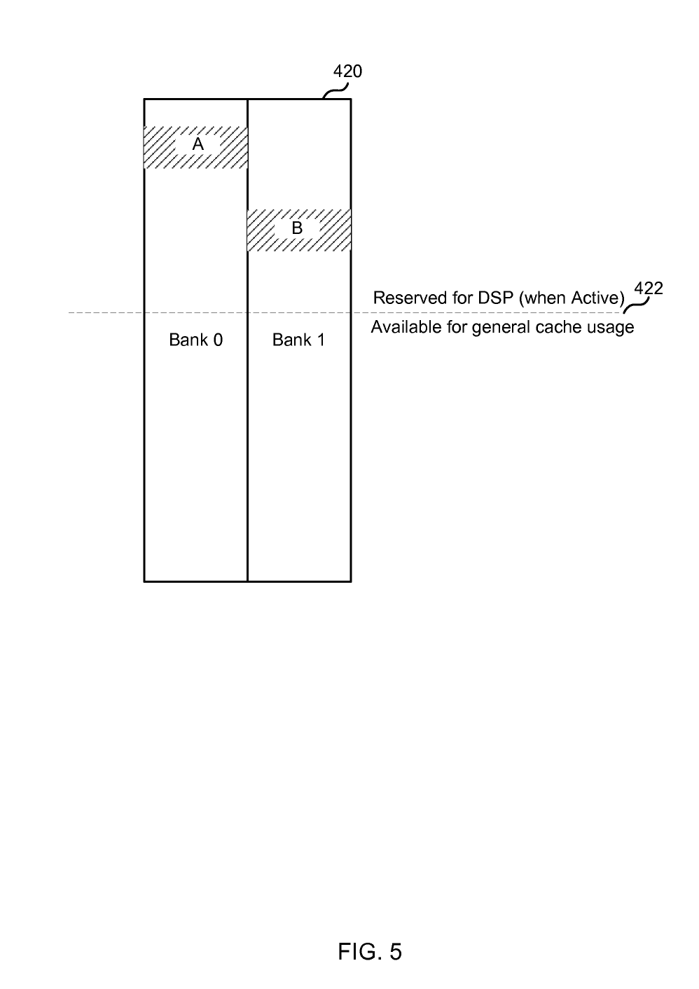

FIG. 5 depicts such banked storage (which may have been implemented by one of the methods above) in the form of example cache 420, where an access to item A is made on the same clock cycle as an independently addressed access to item B. In FIG. 5 a dotted line 422 separates a portion of the cache which is reserved for DSP accesses (when required) and a portion of the cache which is available for general cache usage.

The standard non-DSP-related cache accesses can make use of the multiple ports provided to the structures/banks, and may also opportunistically combine individual cache accesses to perform multiple accesses within a single clock cycle. The individual accesses are not required to be related beyond the independent structure in which they are each accessing (which allows them to be operated together), i.e. the individual accesses are not related and only need to access different storage elements.

Further division of the storage elements by data width may also be performed to allow a greater range of data alignment accesses to be performed. This does not affect the operations described above, but also enables the possibility of operating on multiple data within the same set. In one example this would allow operations to access to an additional element within a cached line to an alternate offset from the first.

The example flow diagram in FIG. 3 also shows the operation upon a context switch, which uses the standard context switch mechanism (blocks 312 and 316) with additional instructions to handle the unlocking and locking of those cache lines used to store DSP data (blocks 310 and 318). These additional instructions may be held in an instruction cache and retrieved by an instruction fetch block before being fed into the execution pipelines. When data is switched out (bracket 308), an instruction navigates the real-estate of the DSP (i.e. the portion of the cache allocated to DSP use) and unlocks those cache lines (block 310) prior to the context switch (block 312). When context is switched in (bracket 314), the cache data, including any DSP data which was previously stored in the cache, is restored from memory (block 316) and then an instruction is used to search for any lines which contain DSP data and to lock and set the state of those lines (block 318). This puts the cache lines used for DSP data back into the same logical state that they were in (e.g. following block 304) as if a context switch operation had not been performed, i.e. the cache lines are protected so that they cannot be written to by anything other than a DSP instruction and any data stored in the cache lines is marked such that it is never written back to memory. Following the context switch (bracket 314) the physical location of the content within the cache may be different (e.g. as the content can be located in any way of the cache according to normal cache policy); however logically this looks the same to the functionality following it.

In an example implementation of block 318, an address indexed data lookup within the MMU may determine the DSP property of accesses through its address range and this could be used in conjunction with a modified cache maintenance operation (which searches the cache for other reasons) to search and update the cache line state back to the locked DSP state.

The controls which are used to unlock and lock lines (in blocks 310 and 318) and the control which is used to lock the lines originally (in block 304) may be stored within the cache itself, e.g. within the tag RAM, or in hardware logic associated with the cache. Existing control parameters within the cache provide locked in cache lines and new additional instructions or modifications to existing instructions are provided to enable these control parameters to be readable and updateable such that the DSP data contents can be saved and restored. This may be implemented purely in hardware or in a combination of hardware and software.

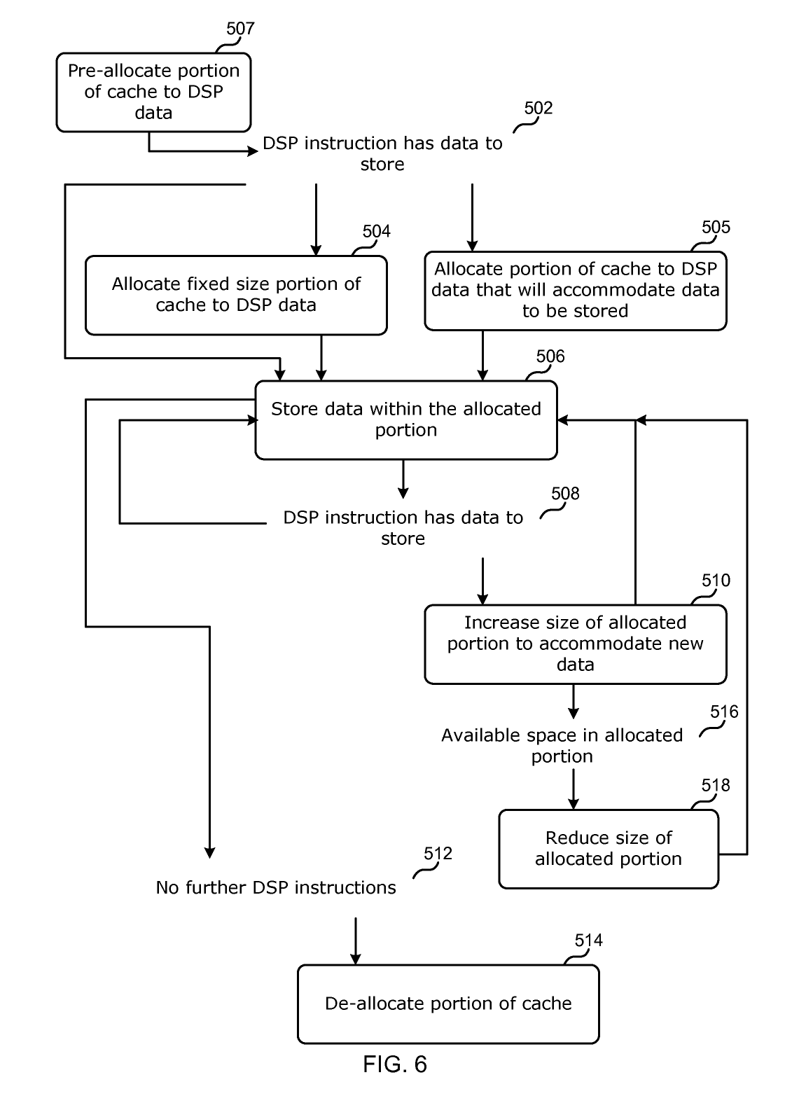

FIG. 6 shows three example implementations of how a portion of a cache may be allocated to the DSP instructions and used to store DSP data (i.e. in block 302 in FIG. 3). In a first example, as soon as a DSP instruction has some data to store (block 502), a fixed size portion of the cache is allocated for use by the DSP instructions (block 504) and the data is stored within the allocated portion (block 506). At this point, all the cache lines within the fixed size portion may, optionally, be locked so that they cannot be written to by anything other than a DSP instruction. By locking the cache lines, this protects the DSP data. Once a cache line has been allocated (in block 504) it is assumed to contain DSP data and so its state is set to ‘write never’. Then when a DSP instruction subsequently has additional data to store (block 508), that data can be stored within the already allocated portion (block 506).

In the second example, as soon as a DSP instruction has some data to store (block 502), a portion of the cache is allocated which is large enough to store that data (block 505) and the allocation is then increased (in block 510) when more data needs to be stored, up to a maximum allocation size. This option is more efficient than the first example, because the amount of cache which is unavailable for normal use (because it is allocated to DSP and locked against use by anything else) is dependent upon the amount of DSP data that needs to be stored; however this second example may add a delay where the size of the allocated portion is increased (in block 510). It will be appreciated that there are a number of different ways in which the increase in allocation (in block 510) may be managed. In one example, the allocated portion may be increased in size when it is not possible to store the new data in the existing allocated portion and in another example, the allocated portion may be increased in size when the remaining free space falls below a predefined amount. It will further be appreciated that the amount allocated initially (in block 505) may be only of a sufficient size to store the required data (from block 502) or may be larger than this, such that the size of the allocated portion does not need to be increased with each new DSP instruction that has data to store but only occurs periodically.

In some implementations of the second example, the allocation may be reduced in size (in block 518) in a reverse operation to that which occurs in block 510, e.g. when there is available space in the allocated portion (block 516). Where this is implemented, the allocated portion grows and shrinks its footprint within the cache which increases efficiency in the use of cache resources.

The allocation (in block 504 or 505) may, for example, be provoked by the DSP instruction accessing a location within a page marked as DSP and finding that it does not have permission to read or write. This would cause an exception and software would prepare the cache with a DSP area (in block 504 or 505).

In a third example, the cache may be pre-prepared such that a portion of the cache is pre-allocated to DSP data (block 507). This means that exception handling would not be caused (as may be the case in the first two examples and trigger the allocation process); however this may require a DSP area to be reserved in the cache earlier than is necessary.

In any of the examples in FIG. 6, when there are no further DSP instructions running (block 512), i.e. at the end of a DSP program, the portion of the cache which was previously allocated (e.g. in block 504 or 505) for use in storing DSP data is de-allocated (block 514). This de-allocation operation (in block 514) may use a similar process to the context switch operation shown in FIG. 3 (bracket 308) with the releasing of lines (as in block 310) but without performing the save operation (i.e. block 312 is omitted). The same process may also be used when reducing the size of the allocated portion (in block 518).

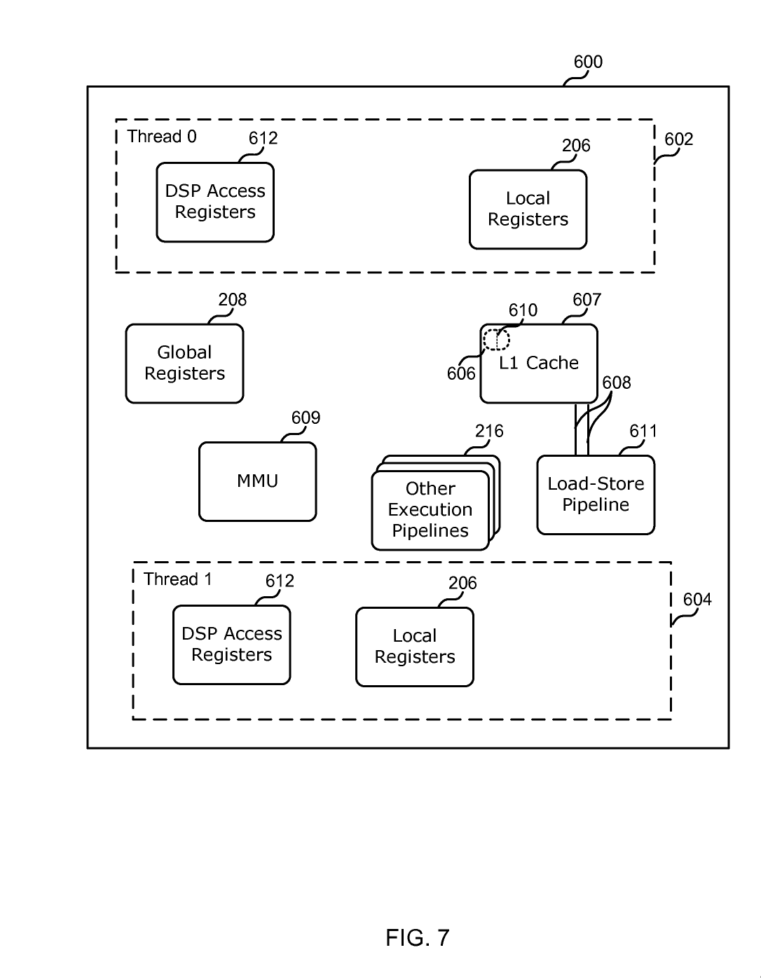

FIG. 7 is a schematic diagram of an example multi-threaded processor 600 which comprises two threads 602, 604. As in the processor shown in FIG. 2, some of the resources are replicated for each thread (e.g. local registers 206 and DSP access registers 612) and some resources are shared (e.g. global registers 208). Unlike the processor 200 shown in FIG. 2, the example processor 600 shown in FIG. 7 does not include any dedicated DSP indirect registers or a DSP access pipeline. Instead, a portion 606 of the L1 cache 607 is allocated, when required, for use by the DSP instructions to store DSP data. The allocation of the portion 606 of the L1 cache 607 may be performed by the MMU 609 and then allocation of actual cache lines may be performed by the cache 607 (e.g. with some software assistance). Although a dedicated pipeline may be provided to store the DSP data, in this example, the load-store pipeline 611 is used. This load-store pipeline 611 is similar to the existing load-store pipeline (element 212 in FIG. 2) with an update to benefit from the multiple ports provided by the L1 cache 607 (e.g. the two load ports and one store port, as described above). This means that additional complex logic is not required and the load-store pipeline can enforce ordering and only performs re-ordering where there is no conflict in addresses (e.g. the load-store pipeline can generally operate as normal with the DSP functions not being treated as special cases). The DSP data is mapped to cache line addresses within the allocated portion 606, instead of to DSP registers, using indexes generated from values stored in related DSP access registers 612. In order that the operation of the cache 607 can mimic the operation of DSP indirect register resource, two channels 608 are provided between the load-store pipeline 611 and the L1 cache 607 and the portion 606 of the cache is partitioned (as indicated by dotted line 610) to provide two separate sets of locations within the portion for the two channels.

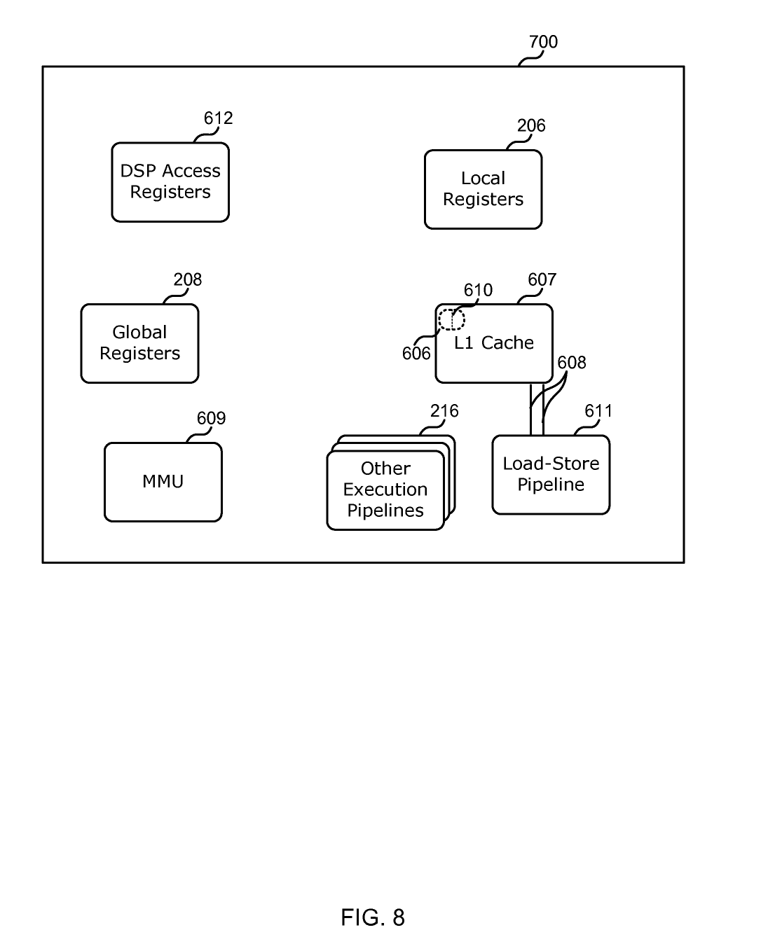

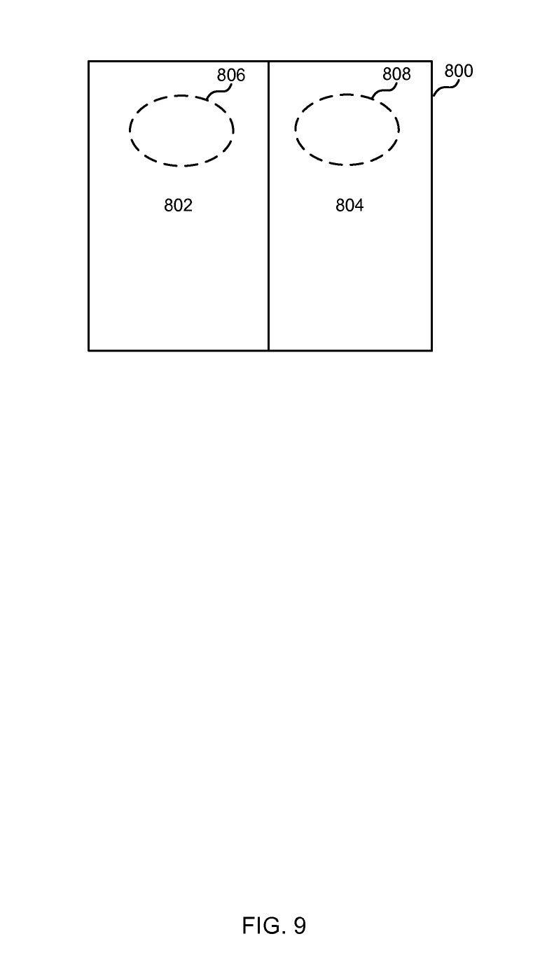

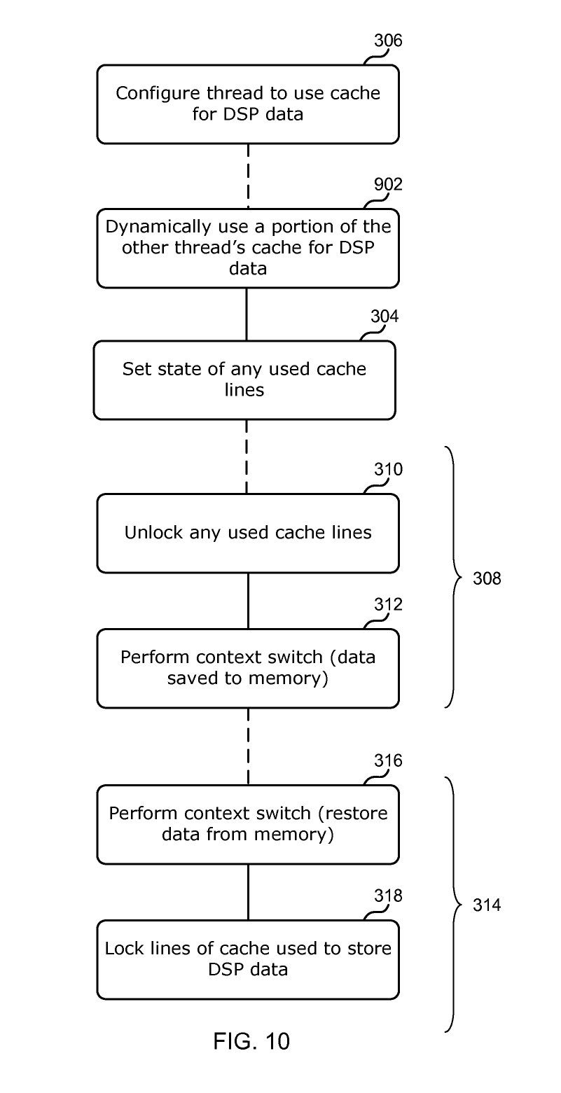

The methods described above may also be implemented in a single-threaded processor and an example processor 700 is shown in FIG. 8, wherein like reference numerals identify like elements of FIG. 7. It will also be appreciated that the methods may be implemented in a multi-threaded processor which comprises more than two threads and/or in a multi-core processor (where each core may be single or multi-threaded).

Where the methods are implemented in a multi-threaded processor, the method shown in FIG. 3 and described above may be modified as shown in FIGS. 9 and 10. As shown in FIG. 9, which is a schematic diagram of an L1 cache 800, the cache 800 is partitioned between the threads. In this example, there are two threads and one part 802 of the cache is reserved for use by thread 0 and the other part 804 of the cache is reserved for use by thread 1. When a portion of the cache is allocated to a thread for storing DSP data (in block 902 of the example flow diagram in FIG. 10), this space is allocated from within the cache resource of the other thread. For example, a portion 806 allocated to thread 1 to store DSP data is taken from the part 802 of the cache which is used by thread 0 and a portion 808 allocated to thread 0 to store data is taken from the part 804 of the cache which is used by thread 1. The remaining steps of FIG. 10 are the same as those in FIG. 3 and will not be repeated. Where only one thread is executing DSP instructions, the other thread sees a reduction in its cache resource whilst the DSP thread (i.e. the thread executing the DSP instructions) maintains its maximum cache space and performance. Where both threads are using DSP, each thread loses a small part of cache space for use for storing the other thread's DSP data.

As described above (e.g. with reference to FIG. 6), the size of the portion 806, 808 which is allocated may be of a fixed size or may vary dynamically.

In some implementations, the methods shown in FIGS. 3 and 10 may be combined such that in some circumstances, cache resources from a thread's own cache space may be allocated for storing DSP data and in other circumstances, cache resources from another thread's cache space may be allocated.

As described above, the allocation of cache resource for use as if it was DSP indirect register resource (i.e. for use in storing DSP data) is performed dynamically. In an example, the hardware logic may periodically perform the allocation of cache resource to threads for use to store DSP data, and the size of any allocation may be fixed or may vary (e.g. as shown in FIG. 6).

Although the above description relates to use of the cache to store DSP data, the modified cache architecture described above and shown in FIG. 7 (e.g. with the increased number of channels 608 between the load-store pipeline and the cache and split cache architecture) may be used by other special instruction sets which also require patterned access to the cache.

The methods and apparatus described above enable an array of indirectly accessed DSP registers (which is typically large compared to other register resource) to be moved into the L1 cache as a locked resource.

Using the methods described above, the overhead associated with provision of dedicated DSP indirect registers is eliminated and through re-use of existing logic (e.g. the load-store pipeline) additional logic to write the DSP data to the cache is not required. Furthermore, where dedicated DSP indirect registers are used (e.g. as shown in FIG. 2), it is necessary to provide mechanisms to ensure coherency given that although writes are performed in order, reads may be performed out of order. Using the methods described above, these mechanisms are not required and instead existing coherency mechanisms associated with the cache can be used.

A particular reference to “logic” refers to structure that performs a function or functions. An example of logic includes circuitry that is arranged to perform those function(s). For example, such circuitry may include transistors and/or other hardware elements available in a manufacturing process. Such transistors and/or other elements may be used to form circuitry or structures that implement and/or contain memory, such as registers, flip flops, or latches, logical operators, such as Boolean operations, mathematical operators, such as adders, multipliers, or shifters, and interconnect, by way of example. Such elements may be provided as custom circuits or standard cell libraries, macros, or at other levels of abstraction. Such elements may be interconnected in a specific arrangement. Logic may include circuitry that is fixed function and circuitry can be programmed to perform a function or functions; such programming may be provided from a firmware or software update or control mechanism. Logic identified to perform one function may also include logic that implements a constituent function or sub-process. In an example, hardware logic has circuitry that implements a fixed function operation, or operations, state machine or process.

Any range or device value given herein may be extended or altered without losing the effect sought, as will be apparent to the skilled person.

It will be understood that the benefits and advantages described above may relate to one embodiment or may relate to several embodiments. The embodiments are not limited to those that solve any or all of the stated problems or those that have any or all of the stated benefits and advantages.

Any reference to an item refers to one or more of those items. The term ‘comprising’ is used herein to mean including the method blocks or elements identified, but that such blocks or elements do not comprise an exclusive list and an apparatus may contain additional blocks or elements and a method may contain additional operations or elements. Furthermore, the blocks, elements and operations are themselves not impliedly closed.

The steps of the methods described herein may be carried out in any suitable order, or simultaneously where appropriate. The arrows between boxes in the figures show one example sequence of method steps but are not intended to exclude other sequences or the performance of multiple steps in parallel. Additionally, individual blocks may be deleted from any of the methods without departing from the spirit and scope of the subject matter described herein. Aspects of any of the examples described above may be combined with aspects of any of the other examples described to form further examples without losing the effect sought. Where elements of the figures are shown connected by arrows, it will be appreciated that these arrows show just one example flow of communications (including data and control messages) between elements. The flow between elements may be in either direction or in both directions.

It will be understood that the above description of a preferred embodiment is given by way of example only and that various modifications may be made by those skilled in the art. Although various embodiments have been described above with a certain degree of particularity, or with reference to one or more individual embodiments, those skilled in the art could make numerous alterations to the disclosed embodiments without departing from the spirit or scope of this invention.

1. A method of managing memory resources within a processor comprising:
dynamically using a locked portion of a cache for storing data associated with DSP instructions; and
setting a state associated with any cache lines in the portion of the cache allocated to and used by a DSP instruction, the state being configured to prevent the data stored in the cache line from being written to memory.

2. A method according to claim 1, wherein dynamically using a portion of a cache for storing data associated with DSP instructions comprises:
allocating a fixed size portion of cache for storing data associated with DSP instructions.

3. A method according to claim 1, wherein dynamically using a portion of a cache for storing data associated with DSP instructions comprises:
allocating a variable size portion of cache for storing data associated with DSP instructions; and
increasing the size of the variable size portion of cache to accommodate storing of further data associated with DSP instructions.

4. A method according to claim 2, further comprising:
de-allocating the portion of cache when no DSP instructions are being run.

5. A method according to claim 1, further comprising:
setting a register to enable the dynamic use of a portion of the cache for storing data associated with DSP instructions.

6. A method according to claim 1, further comprising, when switching data out as part of a context switch:
unlocking any cache lines used to store data associated with DSP instructions prior to performing the context switch.

7. A method according to claim 1, further comprising, when switching data in as part of a context switch:
performing the context switch; and
locking any lines of cache data restored by the context switch which are used to store data associated with DSP instructions.

8. A method according to claim 1, wherein the processor is a multi-threaded processor and wherein dynamically using a portion of a cache for storing data associated with DSP instructions comprises:
dynamically using a portion of a cache associated with a first thread for storing data associated with DSP instructions executed by a second thread.

9. A processor comprising:
a cache;
a load-store pipeline; and
two or more channels connecting the load-store pipeline and the cache; and
wherein a portion of the cache is dynamically allocated for storing data associated with DSP instructions when DSP instructions are executed by the processor and lines within the portion of the cache are locked.

10. A processor according to claim 9, wherein the portion of the cache is divided to provide a separate set of locations within the portion for each of the channels.

11. A processor according to claim 10, wherein the separate set of locations for each of the channels comprise independent storage elements.

12. A processor according to claim 9, wherein the processor does not contain indirectly accessed registers dedicated for storing the data associated with DSP instructions.

13. A processor according to claim 9, further comprising hardware logic arranged to set a state associated with any cache lines in the portion of the cache allocated to and used by a DSP instruction, the state being configured to prevent the data stored in the cache line from being written to memory.

14. A processor according to claim 9, further comprising hardware logic arranged to allocate a fixed size portion of cache for storing data associated with DSP instructions.

15. A processor according to claim 9, further comprising hardware logic arranged to allocate a variable size portion of cache for storing data associated with DSP instructions and to increase the size of the variable size portion of cache to accommodate storing of further data associated with DSP instructions.

16. A processor according to claim 9, further comprising a register which when set enables the dynamic use of a portion of the cache for storing data associated with DSP instructions.

17. A processor according to claim 9, further comprising memory arranged to store instructions which, when executed on context switch, unlock any cache lines used to store data associated with DSP instructions prior to performing the context switch.

18. A processor according to claim 9, further comprising memory arranged to store instructions which, when executed on context switch, lock any lines of cache data restored by the context switch which are used to store data associated with DSP instructions.

19. A processor according to claim 9, wherein the processor is a multi-threaded processor and the cache is partitioned to provide dedicated cache space for each thread and the portion of the cache which is dynamically allocated for storing data associated with DSP instructions executed by a first thread is allocated from the dedicated cache space for a second thread.

20. A method of managing memory resources within a multi-threaded processor comprising:
dynamically using a locked portion of a cache associated with a first thread for storing data associated with DSP instructions executed by a second thread; and
setting a state associated with any cache lines in the portion of the cache allocated to and used by a DSP instruction, the state being configured to prevent the data stored in the cache line from being written to memory.

21. A method of increasing efficiency of memory resources in a processor, the method comprising:
using a portion of cache memory to store DSP instructions and/or data in lieu of storing such instructions and/or data in an indirectly accessed DSP register.
